(19) United States
(12) Patent Application Publication
(10) Pub. No.: US 2025/0319375 A1
(43) Pub. Date: Oct. 16, 2025

(54) SOUND DAMPENING PICKLEBALL TECHNIQUES

(71) Applicant: Sport Squad, Inc., Rockville, MD (US)

(72) Inventors: Fabio Kachiwazaki, São Paulo (BR); Richard Lee, Potomac, MD (US); Austin Kim, Columbia, MD (US)

(21) Appl. No.: 19/214,969

(22) Filed: May 21, 2025

Related U.S. Application Data
(63) Continuation of application No. PCT/US25/23730, filed on Apr. 8, 2025.
(60) Provisional application No. 63/633,952, filed on Apr. 15, 2024.

(51) Int. Cl. A63B 60/54; A63B 59/42; A63B 102/08; B32B 5/02; B32B 5/18; B32B 7/12

(52) U.S. Cl. CPC A63B 60/54; A63B 59/42; A63B 2102/08; A63B 2209/02; A63B 2209/08; A63B 2209/10; B32B 5/022; B32B 5/18; B32B 7/12; B32B 2307/102

(57) ABSTRACT

The present teachings generally include sound dampening devices, systems, kits, and methods for pickleball and the like. In an aspect, a pickleball paddle includes one or more layers having sound dampening properties. In another aspect, a paddle accessory featuring one or more sound dampening materials may be engaged with a pickleball paddle to enable quieter play using the paddle. In yet another aspect, a ball for pickleball play includes one or more layers having sound dampening properties. And, in another aspect, an accessory featuring one or more sound dampening materials may be engaged with a ball to enable quieter play using the ball.

### CROSS-REFERENCE TO RELATED APPLICATIONS

This application is a bypass continuation that claims priority to International Patent Application No. PCT/US25/23730 filed on Apr. 8, 2025, which claims priority to U.S. Provisional Pat. App. No. 63/633,952 filed on Apr. 15, 2024, where each of the foregoing applications are hereby incorporated by reference in their entirety.

### FIELD

The present disclosure generally relates to sound dampening devices, systems, kits, and methods for pickleball and the like, with certain aspects including one or more of: a paddle with sound dampening features, a sound-dampening accessory structurally configured to engage with a paddle, and/or a ball having sound dampening features.

### BACKGROUND

Pickleball is a paddle sport that generally combines elements of tennis, badminton, and ping-pong. It is played on a court with similar dimensions to a badminton court with a net dividing opposing sides. The game is played with a perforated plastic ball and solid paddles made of, for example, wood, graphite, and/or composite materials. In general, players use their paddles to hit the ball over the net, aiming to land the ball within the boundaries of the opposing side of the court. Pickleball is a popular sport among people of all ages and skill levels, where it is known for its relatively simple rules and quick learning curve, making it accessible to beginners while still offering depth and strategy for more experienced players. The sport has grown exponentially in popularity worldwide in recent years, with dedicated courts in parks, community centers, and sports clubs across many communities.

However, many individuals take issue with noises created during pickleball play. The issue of noise in pickleball primarily arises due to the nature of the sport and the equipment used. Pickleball is typically played on a hard surface such as asphalt or concrete, which tends to amplify sound. Moreover, the paddles used in pickleball are typically made of hard materials, which can generate and amplify a significant amount of noise when striking the ball. Several factors contribute to noises generated during pickleball play including: paddle impact, i.e., when players hit the ball with their paddles it can create a sharp distinctive sound due to the impact of hard surfaces; ball impact, i.e., pickleballs are typically made of plastic and have a design with predetermined holes that can collectively create a specific sound when struck by the paddle and/or the ground; and court surface, i.e., the hard surfaces of pickleball courts can reflect and amplify sounds.

Because many pickleball courts are located near residential areas, and/or other areas used for alternative activities (e.g., other exercise, sports or recreational activities, relaxation or leisure activities, and the like), the noise from play can disturb nearby residents and/or other individuals. Moreover, in areas with multiple pickleball courts situated close to one another, the noise from multiple games being played simultaneously can compound and become more disruptive. By way of example, the noise generated by pickleball has been a concern for both players and residents living near pickleball courts. In response, some communities have implemented measures to mitigate noise, such as installing sound barriers around courts, scheduling games during less intrusive times, or simply banning play altogether. Finding a balance between the enjoyment of pickleball and minimizing its impact on surrounding communities and individuals remains an ongoing challenge for players, organizers, and local authorities.

There remains a need for improved sound dampening pickleball techniques.

### SUMMARY

The present teachings generally include sound dampening devices, systems, kits, and methods for pickleball and the like. In an aspect, a pickleball paddle includes one or more layers having sound dampening properties. In another aspect, a paddle accessory featuring one or more sound dampening materials may be engaged with a pickleball paddle to enable quieter play using the paddle. In yet another aspect, a ball for pickleball play includes one or more layers having sound dampening properties. And, in another aspect, an accessory featuring one or more sound dampening materials may be engaged with a ball to enable quieter play using the ball.

In an example aspect, a noise control accessory for a pickleball paddle disclosed herein includes: an outer surface structurally configured for striking a ball; and a sound dampening component structurally configured to engage, directly or indirectly, with a surface of a paddle, the sound dampening component including a first sound dampening material having a lower density than the surface of the paddle, the first sound dampening material structurally configured to reduce noise generated during impact of the paddle with the ball relative to the surface of the paddle directly striking the ball.

Implementations of this example aspect, or any other example aspect described in this summary section or otherwise herein, may include one or more of the following features. The accessory may be a sleeve sized and shaped to fit over at least a majority of a head portion of the paddle. The sleeve may include: an edge separating the outer surface and an opposing surface; and an opening sized and shaped for selective insertion of at least a top portion of the paddle into a pocket defined by a structure of the sleeve. The sleeve may cover an entirety of the head portion of the paddle when the accessory is placed for use on the paddle. The sleeve may cover at least a portion of a throat of the paddle when the accessory is placed for use on the paddle. The sleeve may be removable and replaceable on the paddle. The pocket may be sized and shaped to receive at least a majority of the head portion of the paddle. One or more of the opening and the pocket may be expandable to receive at least the top portion of the paddle, where the opening and/or the pocket is collapsible to conform to a shape of the paddle when disposed thereon. One or more of the opening and the pocket may include an elastic material that provides for its expansion and collapsing. The edge may be formed of the same material as one or more other portions of the accessory. The edge may be substantially elastic to provide a predetermined fit when the accessory is placed for use on the paddle. The accessory may include a bottom surface structurally configured for placement and coupling directly onto the surface of the paddle. The bottom surface may include an affixing mechanism. The affixing mechanism may include a layer formed along the bottom surface. The affixing mechanism may include double-sided tape. The affixing mechanism may include one or more of a hook and loop fastener, a snap, a magnet, and a mechanical keying component. The bottom surface may include an adhesive. The bottom surface may be structurally configured for removal from the paddle after coupling therewith. The bottom surface may be structurally configured for permanent coupling with the surface of the paddle. The first sound dampening material may include a foam material. The foam material may include a plurality of open cells. The foam material may include a plurality of closed cells. The first sound dampening material may include a felt material. The first sound dampening material may include an elastomeric material. The sound dampening component may include a plurality of layers including a first layer comprising the first sound dampening material, and a second layer comprising a second material. The second material may be a sound dampening material. The second material may include a lower density than the surface of the paddle. The second layer may include an adhesive. The second layer may include the outer surface. The plurality of layers may further include a third layer. The first sound dampening material of the first layer may be less dense than each of the second layer and the third layer; the second layer may be disposed above the first layer, the second material of the second layer including at least one of a polyethylene material and an adhesive; and the third layer may define the outer surface for the accessory. The accessory may include a fourth layer comprising an affixing mechanism. The third layer may define the outer surface of the accessory. The outer surface may include the first sound dampening material. The outer surface may include a layer defining a playing surface of the paddle that is coupled with, and covers, at least a majority of the sound dampening component. The outer surface may include one or more of carbon fiber, fiberglass, graphite, a composite material, and a metal. The outer surface may include a textured surface structurally configured for striking the ball and generating a spin on the ball during impact.

In an example aspect, a method of noise control for pickleball disclosed herein includes applying a noise control accessory to a pickleball paddle comprising a core disposed between two faces thereof, the noise control accessory including: an outer surface structurally configured for striking a ball; and a sound dampening component structurally configured to engage, directly or indirectly, with a face of the pickleball paddle, the sound dampening component including a first sound dampening material having a lower density than the face of the pickleball paddle, the first sound dampening material structurally configured to reduce noise generated during impact of the pickleball paddle with the ball relative to the face of the pickleball paddle directly striking the ball. The method may also include, after applying the noise control accessory to the pickleball paddle, striking the ball with the outer surface of the noise control accessory.

Implementations of this example aspect, or any other example aspect described in this summary section or otherwise herein, may include one or more of the following features. Applying the noise control accessory to the pickleball paddle may include sliding the noise control accessory onto a head portion of the pickleball paddle. The noise control accessory may be a sleeve sized and shaped to fit over at least a majority of the head portion of the pickleball paddle. The sleeve may include: an edge separating the outer surface and an opposing surface; and an opening sized and shaped for selective insertion of at least a top portion of the pickleball paddle into a pocket defined by a structure of the sleeve. The method may include expanding one or more of the opening and the pocket to receive at least the top portion of the pickleball paddle, and collapsing the opening and/or the pocket to conform to a shape of the pickleball paddle when disposed thereon. The method may include expanding the edge to receive the pickleball paddle within the pocket, and collapsing the edge to conform to a shape of the pickleball paddle when disposed thereon. The method may include removing the sleeve by sliding it away from the pickleball paddle. The method may include removing the noise control accessory from the pickleball paddle. Applying the noise control accessory to the pickleball paddle may include placing and coupling the noise control accessory directly onto at least one of the two faces of the pickleball paddle.

In an example aspect, a pickleball paddle disclosed herein includes: a first face; a second face; a core disposed between the first face and the second face; and a sound dampening component disposed between each of (i) the core and the first face, and (ii) the core and the second face, the sound dampening component comprising a first sound dampening material having a lower density than each of the first face, the second face, and the core of the paddle, the first sound dampening material structurally configured to reduce noise generated during impact of the paddle with a ball relative to each of the first face and the second face directly striking the ball.

Implementations of this example aspect, or any other example aspect described in this summary section or otherwise herein, may include one or more of the following features. The sound dampening component may include a plurality of layers including a first layer comprising the first sound dampening material, and a second layer comprising a second material. The second material may be a sound dampening material. The second layer may include an adhesive. The plurality of layers may further include a third layer. The third layer may define a face of the paddle. A layer of the plurality of layers may define a face of the paddle.

In an example aspect, a pickleball ball disclosed herein includes: a first portion formed of a rigid plastic material, the first portion having a substantially spherical shape, the first portion including a plurality of holes about a surface thereof, the plurality of holes leading to an interior portion that is substantially hollow; and i a second portion including a sound dampening material disposed at least partially on the surface of the first portion, the sound dampening material having a lower density than the rigid plastic material, the sound dampening material structurally configured to reduce noise generated during impact with a paddle or playing surface relative to the first portion without the second portion disposed thereon.

Implementations of this example aspect, or any other example aspect described in this summary section or otherwise herein, may include one or more of the following features. The pickleball may include flight and bounce characteristics that comply with one or more predetermined pickleball standards. The sound dampening material may include a foam material. The sound dampening material may include at least one of a thermoplastic, a thermoplastic elastomer, or an elastomeric material. The second portion may be removably coupled to the first portion. The second portion may be a cover that can be selectively applied to the first portion. The first portion may be an existing pickleball ball. The cover may include a cutout structurally configured for receiving the first portion such that the second portion substantially envelopes the first portion. The cover may be substantially elastic relative to the first portion. The cover may be one piece. The cover may include at least two pieces that are structurally configured to attach to each other about the first portion. The at least two pieces may be attached via a mechanical engagement. The pickleball may include an adhesive for coupling the second portion to the first portion. The second portion may be permanently affixed to the first portion. The pickleball may be formed via an injection molding process that includes two distinct shots of injection molded material. The second portion may include a predetermined pattern of the sound dampening material disposed on the surface of the first portion. The predetermined pattern may be one or more of a weave pattern, a crisscross pattern, or a web pattern. The predetermined pattern may cover less than an entirety of the surface of the first portion. The second portion may include regions covering at least a portion of one or more of the plurality of holes. The second portion may not cover any portion of the plurality of holes. The surface of the first portion upon which the second portion is disposed may be an outer surface of the pickleball. The surface of the first portion upon which the second portion is disposed may be an inner surface of the pickleball. The second portion may be structurally configured to dampen vibration caused by impact of the pickleball with the paddle or playing surface.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1A shows a pickleball paddle, by way of example.

FIG. 1B shows a pickleball paddle, by way of example.

FIG. 2 shows a pickleball paddle with one or more sound dampening features, in accordance with a representative example.

FIG. 3 shows a pickleball paddle with one or more sound dampening features, in accordance with a representative example.

FIG. 4 shows a pickleball paddle with a sound dampening feature being applied thereon, in accordance with a representative example.

FIG. 5 shows a cutaway view of a sound dampening feature, in accordance with a representative example.

FIG. 6 shows an accessory for a pickleball paddle, in accordance with a representative example.

FIG. 7 shows a front view of an accessory engaged with a pickleball paddle, in accordance with a representative example.

FIG. 8 shows a side view of an accessory engaged with a pickleball paddle, in accordance with a representative example.

FIG. 9 is a flow chart of a method of noise control for pickleball, in accordance with a representative example.

FIG. 10 shows a pickleball ball with one or more sound dampening features, in accordance with a representative example.

FIG. 11 shows an accessory for a ball and a pickleball ball, in accordance with a representative example.

FIG. 12 shows a cutaway view of a pickleball ball with one or more sound dampening features, in accordance with a representative example.

FIG. 13 shows a cutaway view of a pickleball ball with one or more sound dampening features, in accordance with a representative example.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, and methods disclosed herein relate to sound dampening devices, systems, kits, and methods for pickleball and the like. That is, the present teachings may include features that can quiet certain sounds created when playing pickleball relative to the typical volume of these sounds when pickleball is played without using the techniques of the present teachings. And, in certain aspects, the present teachings may include one or more sound dampening features for pickleball that otherwise do not adversely affect and/or impede standard pickleball play.

It will be understood that, while this disclosure may emphasize the present teachings in the context of pickleball, the present teachings may be adapted and practiced in other sports and activities, including without limitation one or more of: tennis, badminton, squash, racquetball, table tennis (ping pong), and the like. Thus, it shall be understood that, unless expressly stated to the contrary, or otherwise clear from the context, the present teachings are intended to include comparable equipment in other sports/activities in addition to, or instead of, pickleball.

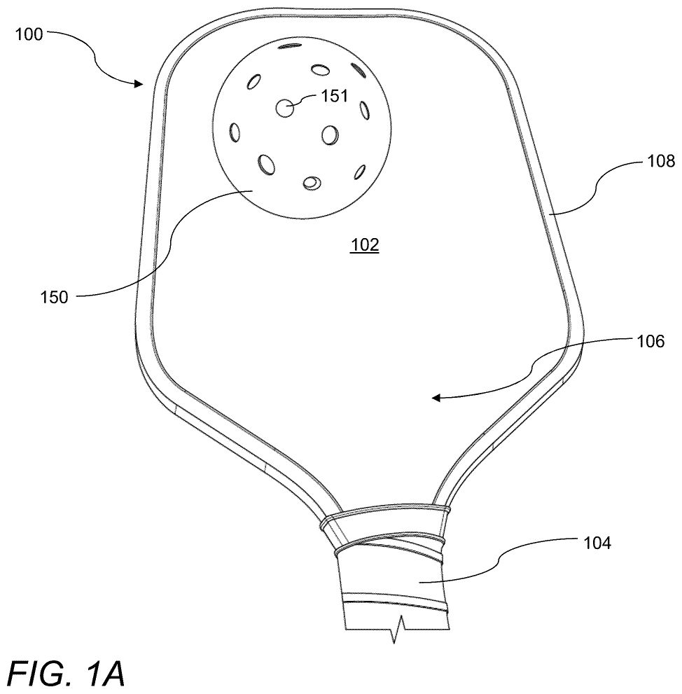

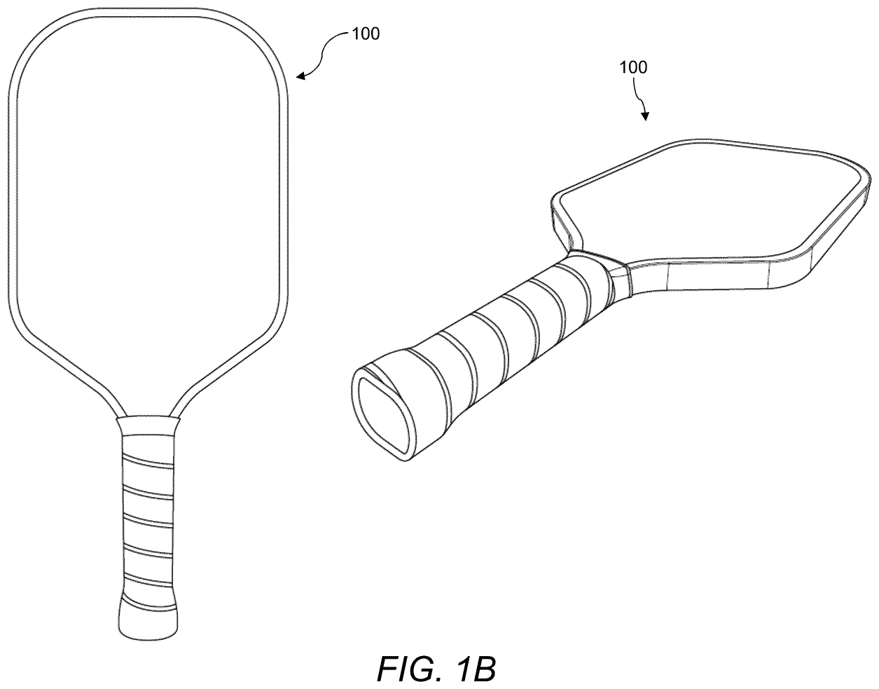

Before describing certain aspects of the present teachings, pickleball equipment according to an example in the prior art will be described with reference to FIGS. 1A and 1B.

FIGS. 1A and 1B show a pickleball paddle, by way of example. That is, FIG. 1A shows both a paddle 100 (i.e., a “pickleball paddle”) and a ball 150 (i.e., a “pickleball” or “pickleball ball”), and FIG. 1B shows several additional views of the paddle 100, where each of the paddle 100 and the ball 150 are structurally configured for playing pickleball therewith according to the prior art. In general, the paddle 100 includes a face 102 structurally configured for striking the ball 150, a handle 104, a throat portion 106 disposed between the face 102 and the handle 104, and an edge portion 108 that may include an edge guard thereon.

The paddle 100 may be made at least in part from one or more composite materials such as fiberglass and/or carbon fiber. The paddle 100 may also or instead be made from one or more of: wood, graphite, metal (e.g., aluminum), a polymer, and the like.

The paddle 100 may adhere to one or more standard specifications, such as those set by USA Pickleball or the like (e.g., via the “USA Pickleball Equipment Standards Manual,” Version 2.0, November 2023 available at https://usapickleball.org/docs/eec/Equipment-Standards-Manual.pdf and hereby incorporated by reference herein). For example, the paddle 100 may conform to a certain standard for material, e.g., it may be made from a rigid, non-compressible material; the paddle 100 may conform to a certain standard for surface roughness, e.g., not containing holes, indentations, rough texturing, or any objects or features that allow a player to impart excessive spin on the ball; the paddle 100 may conform to a certain standard for reflection; the paddle 100 may conform to a certain standard for size, e.g., that the combined length and width, including any edge guard and butt cap, does not exceed 24 inches (60.96 cm), with a paddle length that cannot exceed 17 inches (43.18 cm); the paddle 100 may conform to a certain standard for weight; and the like.

The ball 150 may be made from a plastic material, and may include a plurality of holes 151 that reduce the speed of the ball 150 and create a characteristic sound when the ball 150 is struck. The ball 150 may be structurally configured to bounce relatively well on hard surfaces like asphalt or concrete, which are commonly used for pickleball courts. The ball 150 may be made from one or more plastic polymers, e.g., polyethylene and/or polypropylene. The ball 150 may be an “outdoor” pickleball, which may use harder plastics, such as polyethylene and/or acrylonitrile butadiene styrene (ABS), to withstand harsher conditions like wind and rough surfaces. Such an outdoor pickleball may have more holes (usually around 40) to minimize wind resistance and ensure a stable flight path, relative to an indoor pickleball (usually around 26 holes). The ball 150 may instead be an “indoor” pickleball, which are often made from softer plastics like polypropylene, to provide better control and a more predictable bounce on smooth surfaces. Such an indoor pickleball may have fewer, larger holes to reduce drag and enhance control. The manufacturing process used for the ball 150 may also affect its performance, e.g., where injection molding may produce balls with seams and higher bounce, while rotational molding may create seamless balls that are faster and more durable.

The ball 150 may adhere to one or more standard specifications, such as those set by USA Pickleball or the like. For example, the ball 150 may conform to a certain standard for size, e.g., specifying that the ball shall be 2.87 inches (7.29 cm) to 2.97 inches (7.54 cm) in diameter, with a maximum out-of-round diameter variance no greater than +/−0.020 inch (0.51 mm); the ball 150 may conform to a certain standard for weight, e.g., specifying that the ball shall be between 0.78 ounces (22.1 grams) and 0.935 ounces (26.5 grams); the ball 150 may conform to a certain standard for bounce, e.g., specifying that the ball shall have a bounce of 30 to 34 inches (76.2 to 86.4 cm) to the top of the ball when dropped from a height of 78 inches (198.1 cm) onto a granite surface plate that is a minimum of 12 inches (30.5 cm) by 12 inches (30.5 cm) by 4 inches (10.2 cm), where the test is to be performed at an ambient temperature of 70 degrees F. plus or minus 5 degrees F.; the ball 150 may conform to a certain standard for compression, e.g., specifying that the ball shall, undergoing a test performed in accordance with (IAW) ASTM F1888-09, yield an average compression test result of <43 LBF; the ball 150 may conform to a certain standard for hardness, e.g., having a hardness of 40 to 50 on a Durometer D scale at an ambient temperature of 70 degrees F. plus or minus 5 degrees F.; the ball 150 may conform to a certain standard for design, e.g., having 26-40 circular holes with a spacing conforming to certain characteristics; and the like. Other sizes and characteristics are also or instead possible.

Having described an example of a typical pickleball paddle and ball, the description now turns to devices, systems, kits, and methods for providing certain advantageous sound dampening for pickleball play. It will be understood that the present teachings may be used while still adhering to one or more pickleball related standards, such as any as described above or otherwise known in the sport.

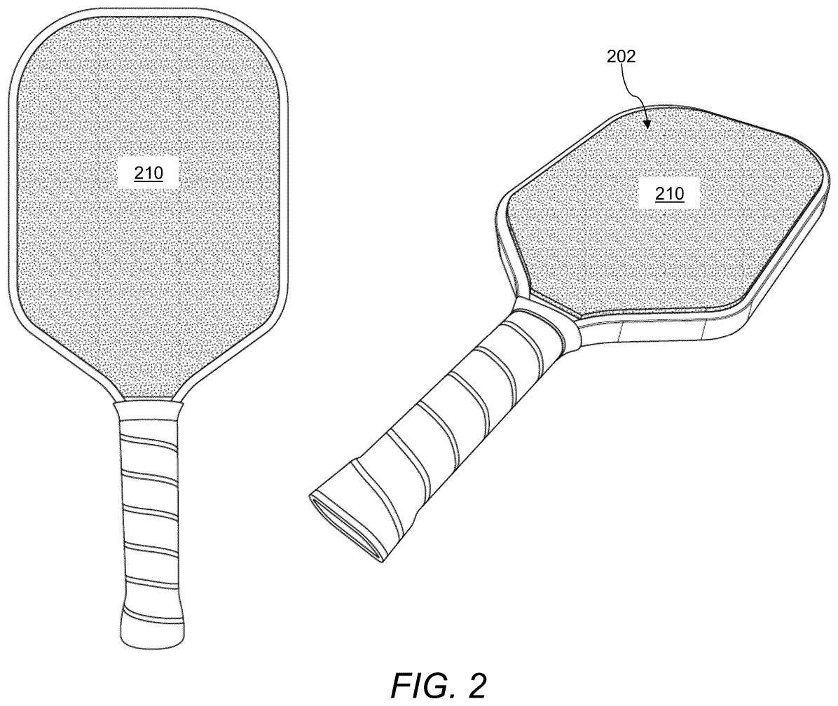

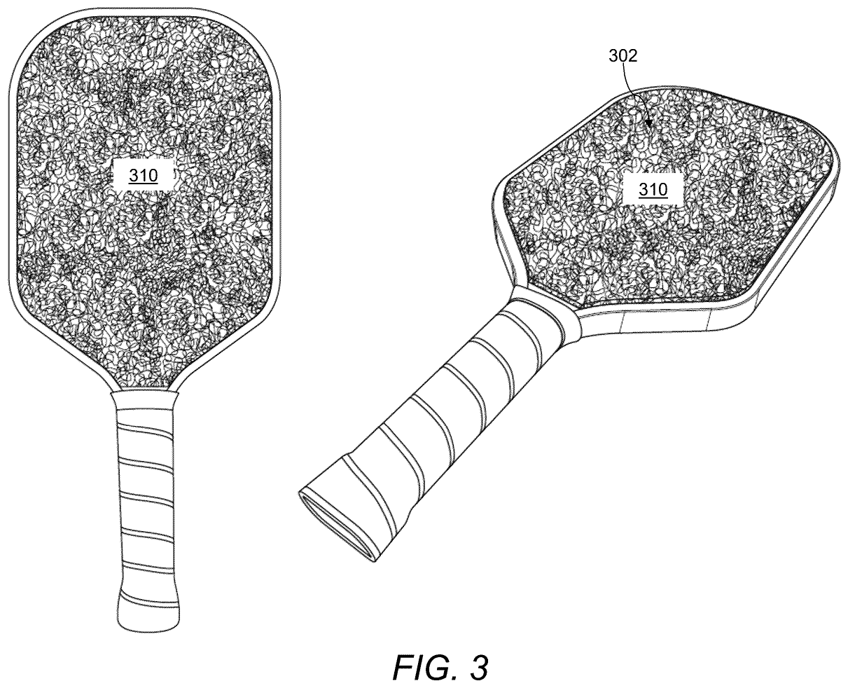

FIG. 2 shows a pickleball paddle with one or more sound dampening features, in accordance with a representative example, and FIG. 3 shows a pickleball paddle with one or more sound dampening features, in accordance with a representative example. In particular, the paddles shown in these figures may include one or more sound dampening features such that, when the paddles strike a ball, sound generated from that strike may be less than what would otherwise be generated if the paddles lacked such features.

As shown in the figures, a face of a paddle may include one or more sound dampening materials 210, 310. In an aspect, and as shown in FIG. 2, a sound dampening material 210 may include a foam or the like. Such a material may include foam made of one or more of a thermoplastic, a thermoplastic elastomer, and/or other elastomeric materials. By way of example, such materials may include one or more of polyethylene, polyurethane, ethyl vinyl acetate (EVA), polystyrene, polyolefin elastomer, thermoplastic vulcanizate, and the like. Such a foam material may also or instead include one or more of a closed cell foam and an open cell foam, e.g., made of a polyethylene or similar. A sound dampening material 210 may also or instead include one or more of the following: viscoelastic polymers, elastomers, foams (including, e.g., polyurethane, EVA, and silicone-based foams), composite structures incorporating rubber and/or thermoplastic layers, and/or advanced materials such as sorbothane, aerogels, fiber-reinforced damping composites, and the like—where these materials may be applied as a continuous layer, a fabric, and/or a mesh. A sound dampening material 210 may also or instead include a special resin with vibration dampening properties that can impregnate a carbon fiber component such as a surface of the paddle.

Also or instead, and as shown in FIG. 3, a sound dampening material 310 may include a felt or the like—e.g., a material made by matting, condensing, and pressing fibers together. Such a felt can be made of one or more of: a natural fiber (e.g., wool or the like), a synthetic fiber (e.g., acrylic, rayon, or the like), and so on. Similar to the materials described above, one or more of the materials comprising the sound dampening material 310 may be applied as a continuous layer, a fabric, and/or a mesh.

Other materials are also or instead possible. For example, in general, nearly any material (e.g., sheet of material) that has a relatively low density may be used, as materials with a high void volume can be helpful with noise dampening while not adding a significant, undesirable weight to a paddle. These materials can have a variety of porosity, density, and/or frequency effectiveness.

The sound dampening material 210, 310 may be featured on a layer of material that is coupled to the paddle, e.g., adhered or otherwise coupled to a core or other surface of the paddle. In some aspects, the sound dampening material 210, 310 wholly defines one or more layers of the paddle. By way of example, in certain implementations, a core of the paddle includes an outer surface, and one or more layers including one or more sound dampening materials 210, 310 are adhered or otherwise coupled to the core to form a sound dampening surface for the paddle, e.g., on its face and throat portion. In some instances, the sound dampening material 210, 310 may extend onto the handle of the paddle.

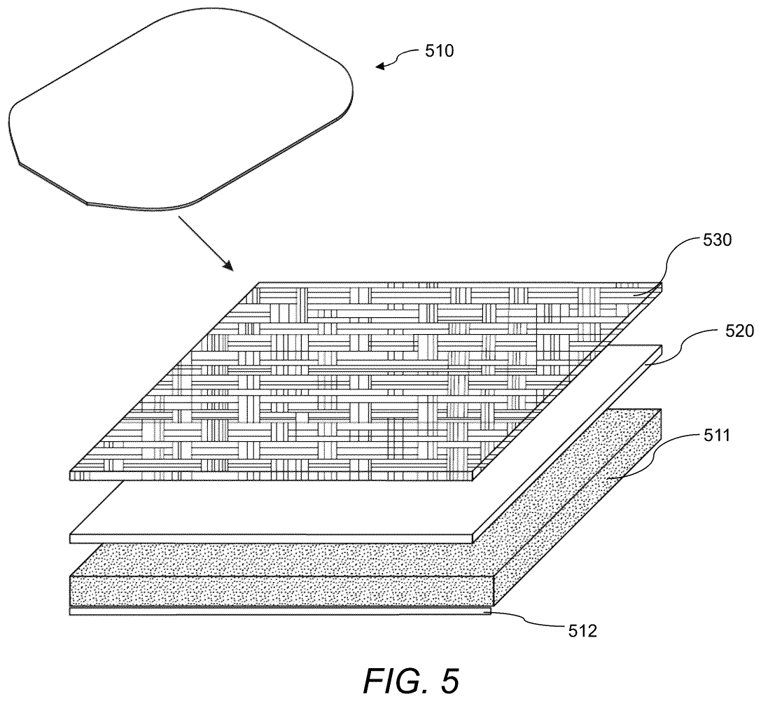

In some aspects, the sound dampening material 210, 310 itself defines the playing surface by forming at least part of the outermost surface of the paddle that is configured to strike a ball. In this manner, the sound dampening material 210, 310 may be structurally configured to strike a ball in a predetermined manner, where such a predetermined manner may mimic traditional pickleball play, but for enhanced sound dampening qualities. To achieve this, in an aspect, a layer similar to a traditional playing surface for the face of a pickleball paddle may be disposed directly beneath the sound dampening material 210, 310, or similar. Also or instead, and as demonstrated by the various layers described herein such as in reference to FIG. 5, a vibration and/or sound dampening layer may include a textured layer adjacent thereto (e.g., on top) to mimic the surface of a standard pickleball paddle and to provide a similar coefficient of friction, roughness, and/or spin generation. This textured layer could be similar to a traditional playing surface such as carbon fiber with resin.

In other aspects, the sound dampening material 210, 310 is disposed beneath a layer that defines the playing surface (the outermost surface) of the paddle. That is, in some aspects, the sound dampening material 210, 310 may be disposed beneath (directly beneath, or indirectly beneath with one or more other layers therebetween) a playing surface of the paddle. For example, in an aspect, a textured layer similar to a traditional playing surface for the face of a pickleball paddle may be the outermost surface of the paddle (e.g., where this playing surface is made of one or more of a carbon fiber, a fiberglass, graphite, a composite material, a metal, aramide (Kevlar), or similar), and one or more layers featuring one or more sound dampening materials 210, 310 is disposed underneath this outermost playing surface, between the playing surface and the core of the paddle.

In certain implementations, the sound dampening material 210, 310 may be part of a replacement surface for a pickleball paddle. That is, an aspect of the present teachings includes an accessory that can transform an existing pickleball paddle into a sound-dampening pickleball paddle (e.g., a “quiet paddle”). In this manner, pickleball players may be able to attach such a replacement surface to a paddle to play in areas where noise is controlled, and they can remove this replacement surface if desired, e.g., to play somewhere else, to play in a tournament, and the like. Further, such a replacement surface may be removable in a non-destructive manner permitting replacement on the paddle in a configuration substantially the same as the configuration prior to removal. When formed as part of a replacement surface, double-sided tape or the like may be used, where such tape may be configured to leave little to no residue on the paddle. Other adhesives such as a glue or epoxy may also or instead be used. Other coupling means are also or instead possible, including one or more of the following: a hook and loop fastener, snaps, magnets, buttons, other mechanical keying components, clamps, clips, dowels, friction fits, snap fits, adhesive, latches, pins, screws, sliders, and the like. Such coupling means may, for example, be present on an interior surface of the sound dampening material 210, 310 (e.g., the surface opposite the top surface 202, 302) and may be configured to couple to the core of the paddle.

In certain implementations, the sound dampening material 210, 310 may be permanently affixed to a pickleball paddle, e.g., as the outermost surface on a face thereof, or disposed beneath the outermost surface on a face thereof (e.g., adjacent to the paddle core). It is also possible for the sound dampening material 210, 310 to sandwich other non-sound dampening materials, e.g., in a multi-layer surface for a pickleball paddle.

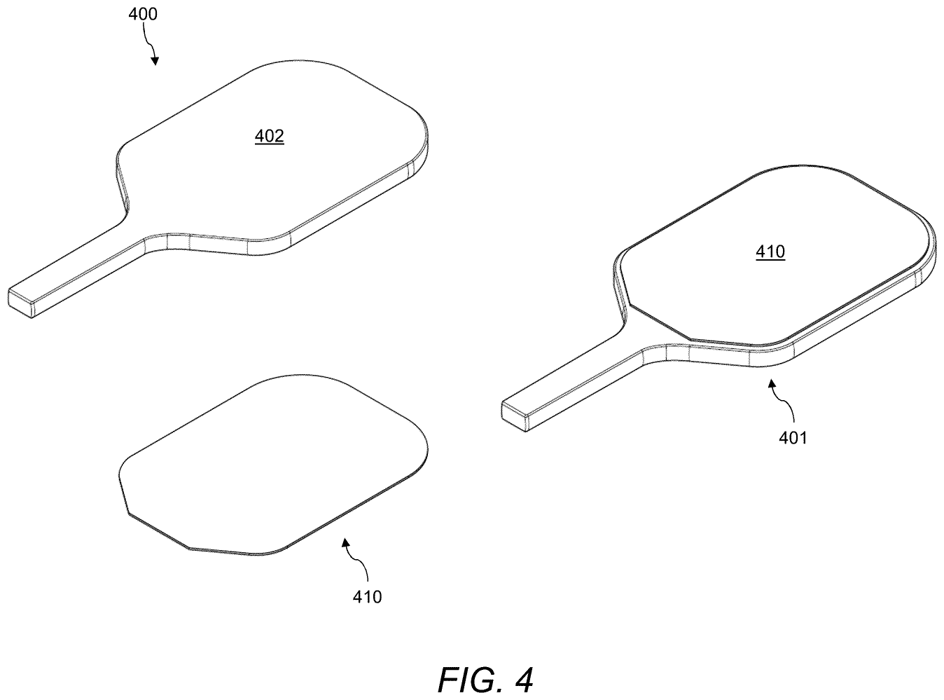

FIG. 4 shows a pickleball paddle with a sound dampening feature being applied thereon, in accordance with a representative example. That is, this figure shows an example embodiment where a sound dampening feature—e.g., a sound dampening surface 410 may be placed onto an existing paddle 400, e.g., a face 402 thereof, to convert a traditional paddle 400 into a sound dampening paddle 401. Although only one side of the sound dampening paddle 401 is shown with the sound dampening surface 410 applied thereon, it will be understood that the sound dampening surface 410 may be found on both faces 402 of an existing paddle 400 to form the sound dampening paddle 401. Alternatively, a user may only apply the sound dampening surface 410 to one face 402 of an existing paddle 400.

It will be understood that the sound dampening surface 410 may be permanently affixed to the sound dampening paddle 401 in an embodiment. Alternatively, in other aspects, the sound dampening surface 410 may be removably and replaceably coupled to the sound dampening paddle 401—e.g., using double-sided tape or the like, or any other fastener or coupling means described herein or known in the art.

FIG. 5 shows a cutaway view of a sound dampening feature, in accordance with a representative embodiment. By way of example, the sound dampening feature 510 may be the same as, or similar to, the sound dampening surface 410 of FIG. 4, or any other as described herein. In general, FIG. 5 shows a representation of an exploded view featuring one or more layers that can be used to form the sound dampening feature 510. Although three layers are shown, more or fewer layers are also or instead possible. One or more of these layers—e.g., collectively all of these layers—may provide sound dampening properties for a pickleball paddle when striking a ball or the like. The layers may include a first layer 511, a second layer 520, and a third layer 530, where, again, one or more of these layers may include features configured for sound dampening such as any as described herein.

The first layer 511 may include a sound dampening material. For example, the first layer 511 may include a cotton material or similar, such as a thickened pearl cotton material. The first layer 511 may also or instead be composed of one or more other materials that act as a sound dampener. By way of example, the first layer 511 may include a combination of EVA and polyethylene (PE). In general, first layer 511 may have a relatively low density, e.g., when compared to one or more of the second layer 520 and the third layer 530. Stated otherwise, the first layer 511 may have a lower density than each of the second layer 520 and the third layer 530, and/or the first layer 511 may have the lowest density relative to any other layers that form part of the paddle and/or its surface.

The first layer 511 may be configured to be affixed to a pickleball paddle through one or more of a plurality of means. By way of example, the sound dampening feature may include an affixing mechanism 512, which may be placed in discreet areas on an underside of the first layer 511 and/or on a paddle itself. In some aspects, the affixing mechanism 512 is a layer formed on an underside of the first layer 511, e.g., the whole underside or a portion thereof. In certain aspects, the affixing mechanism 512 includes a double-sided tape or the like, e.g., formed as a layer beneath the first layer 511. The affixing mechanism 512 may also or instead include any as described herein, such as one or more of the following: a glue, a tape, a paste, a hook and loop fastener, an epoxy, a coating of adhesive, a non-woven adhesive fabric, and the like. In general, the affixing mechanism 512 may couple the sound dampening feature 510 to a surface of a paddle by forming a bond between surfaces, e.g., through chemical reactions, surface interactions, and/or mechanical interlocking. The coupling of the sound dampening feature 510 to a surface of a paddle may be temporary or permanent. Regardless, the coupling should be able to withstand forces seen during typical play of pickleball such that the sound dampening feature 510 does not disengage—partially or wholly—with a surface of a paddle during play.

The second layer 520 may include an adhesive or similar between the first layer 511 (e.g., a sound dampening layer) and the third layer 530 (e.g., a layer that will act as a playing surface for a paddle engaged with the sound dampening feature 510). The second layer 520 may also or instead include a polyethylene material or the like. More generally, in some aspects, the second layer 520 may also or instead include sound dampening properties or other functionality. The second layer 520 (and/or another layer) may also or instead include a pressure-sensitive adhesive, a thermosetting and/or thermoplastic adhesive, an epoxy resin, a polyurethane-based adhesive, an elastomeric bonding agent, double-sided tape, and/or any material to provide predetermined adhesion. The second layer 520 may also or instead be a textured layer as described herein. For example, the second layer 520 may be an epoxy layer with a texture disposed thereon. In some instances, this may negate any need for a third layer 530. The second layer 520 may also or instead include a polymer, foam, or fiber.

The third layer 530 may include a layer configured for placement as the outermost playing surface for a face of a pickleball paddle, e.g., a textured layer. The third layer 530 may be used to replicate something similar to an original texture of a paddle that is intended for coupling with the sound dampening feature 510 to form a “quiet paddle” or similar.

The texture on the third layer 530 may be structurally configured to generate spin when hitting the ball. Without such texture (i.e., when the playing surface is too smooth) it can be difficult to add spin. On the other hand, too much texture (i.e., being too rough or having too high of a coefficient of friction) can be a problem by adding too much spin, potentially giving a player an unfair competitive advantage. Thus, in some aspects, the third layer 530 may be used to adjust the roughness, coefficient of friction (COF), durability (wear resistance), and/or aesthetics (e.g., with printed logos, text, and/or graphics over or under the texture to change the aesthetic), or similar. And, in some aspects, the third layer 530 may be used to adjust one or more mechanical properties such as hardness, compression strength, coefficient of restitution, and the like.

The third layer 530, or more particularly a textured surface thereof, can be made in different ways and can include one or more materials. For example, the third layer 530 can be a fabric with a weave pattern; a thermoset resin with a pattern (e.g., peel ply method); a sandblasted surface; a sandpaper texture surface where sand is added to modify the roughness; a polymeric material with textured stamping process; and so forth.

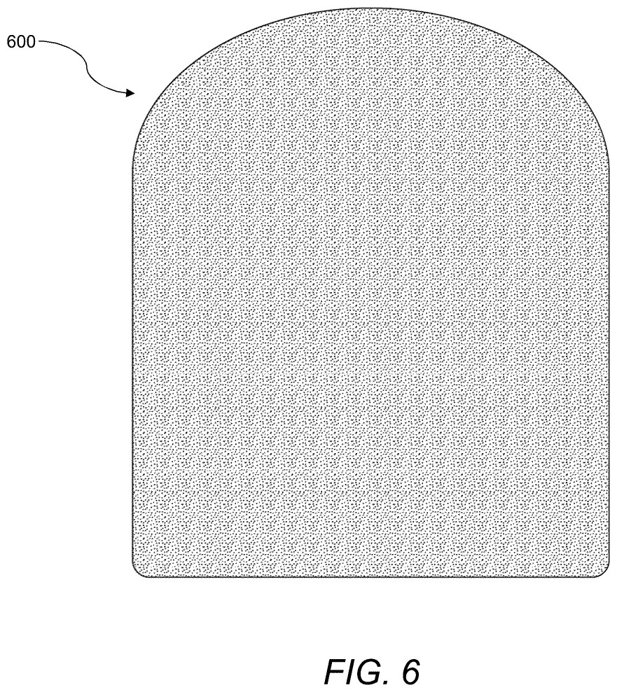

In certain aspects, the present teachings include an accessory structurally configured to be engaged with a pickleball paddle, where the accessory provides sound dampening properties. For example, such an accessory may include a sleeve or the like that can be coupled with a pickleball paddle—e.g., slid over top of an existing pickleball paddle—to provide a removable and replaceable sound dampening surface for play. An example is shown in FIGS. 6-8 described below.

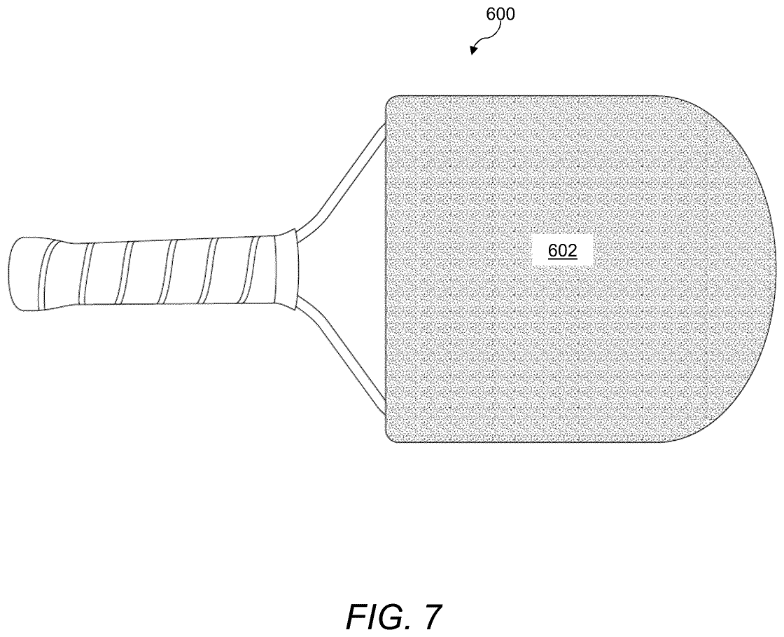

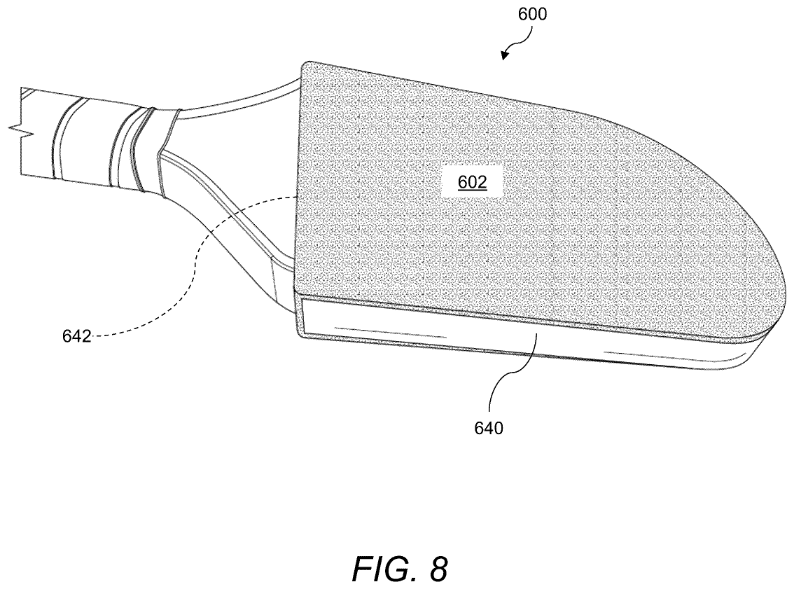

FIG. 6 shows an accessory for a pickleball paddle, FIG. 7 shows a front view of the accessory engaged with a pickleball paddle, and FIG. 8 shows a side view of the accessory engaged with the pickleball paddle, in accordance with a representative example.

The accessory 600 may include one or more of the sound dampening materials as described herein, e.g., a foam material, a felt material, a rubber or other elastomeric material, and/or the like. The accessory 600 may also or instead include an outer surface having a textured surface or similar, as described herein—e.g., a surface structurally configured for striking a ball during play. The accessory 600 may be structurally configured to engage with a pickleball paddle to enable a user to play pickleball with the combination of the accessory 600 and the paddle.

The accessory 600 may be shaped as a sleeve, and sized to fit (snugly) over a pickleball paddle. That is, the accessory 600 may define a pocket sized and shaped to receive at least a top portion of a pickleball paddle. In some aspects, the accessory 600 may be sized and shaped such that, when engaged with a pickleball paddle, the accessory 600 covers a substantial portion of the face of the pickleball paddle. For example, the accessory 600 may be sized and shaped to cover the entire face of the pickleball paddle. In some aspects, the accessory 600 may be sized and shaped to cover at least some of the throat portion of the pickleball paddle, e.g., all of the throat portion of the pickleball paddle in a manner similar to the sound dampening material 210, 310 shown in FIG. 2 and FIG. 3.

The accessory 600 may include an edge 640 that may be formed of the same material as one or more other portions of the accessory 600 or may be formed of a different material. In some aspects, the edge 640 of the accessory 600, or a portion thereof, is substantially elastic, which can help promote a snug fit when the accessory 600 is placed for use on the pickleball paddle.

Thus, the accessory 600 may be a sleeve sized and shaped to fit over at least a majority of a head portion of a paddle, where the sleeve includes an edge 640 separating the outer surface (i.e., the face portion 602) and an opposing surface (i.e., an opposing face portion disposed opposite the viewable face portion 602 in the figures), and an opening 642 sized and shaped for selective insertion of at least a top portion of the paddle into a pocket defined by a structure of the sleeve. In this manner, the pocket shall be understood to include the interior space (i.e., void) that is occupied at least in part by the head portion of the paddle when the accessory 600 is applied thereon. To this end, the pocket may be sized and shaped to receive at least a majority of the head portion of the paddle.

The sleeve may cover an entirety of the head portion of a paddle when the accessory 600 is placed for use on the paddle. The sleeve may also or instead cover at least a portion of a throat of the paddle when the accessory 600 is placed for use on the paddle. As discussed herein, the sleeve may be removable and replaceable on a paddle.

In certain aspects, one or more of the opening 642 and the pocket is expandable to receive at least the top portion of a paddle. Similarly, one or more of the opening 642 and the pocket may be collapsible to conform to a shape of the paddle when disposed thereon. The expandable nature of the opening 642 and/or pocket may be achieved through the use of elastic materials, such as elastomeric fabrics or bands, incorporated into the structure. By way of example, this elasticity may allow the opening 642 to stretch temporarily to accommodate paddles of various sizes and shapes, and then return to its original form to ensure a snug fit. The opening 642 and/or pocket may also or instead feature pleated or gathered sections that can unfold to increase capacity when receiving a paddle, then fold back to reduce excess material once the paddle is inserted. In some implementations, the opening 642 and/or pocket may include adjustable elements, such as drawstrings, hook-and-loop fasteners, or snap closures, which allow users to customize the fit around different paddle shapes and sizes. The collapsible aspect of the opening 642 and/or pocket may be facilitated by using flexible, yet durable materials that can easily conform to the contours of the paddle. This conformity may help maintain the paddle's original playing characteristics while providing the desired sound dampening effects. The material may include strategically placed creases or folds that allow it to collapse neatly around the paddle's edges and corners. In some cases, the expandable and collapsible features may work in tandem, with the opening 642 expanding to allow easy insertion of the paddle, then collapsing along with the pocket to create a smooth, wrinkle-free surface over the paddle face. This design may help ensure that the sound dampening accessory does not interfere with the paddle's performance during play. The expandable and collapsible properties may also contribute to the ease of application and removal of the sound dampening accessory 600, potentially allowing players to quickly switch between dampened and undampened play as needed. Additionally, these features may help in storing the accessory 600 when not in use, as it can collapse into a more compact form for easy transport or storage. Other configurations of the sleeve are also or instead possible.

The edge 640 may be formed of the same material as one or more other portions of the accessory 600, or it may be formed of a different material. The edge 640 may be substantially elastic to provide a predetermined fit when the accessory 600 is placed for use on a paddle. Thus, the edge 640 may also or instead include any of the elastic features and functionality described above with respect to the opening 642 and/or pocket. In general, including elastic components may allow the edge 640 to stretch and conform to a paddle's shape while maintaining tension to keep the accessory 600 securely in place.

In some aspects, the elasticity of the edge 640 may vary along different portions of the accessory 600. For instance, the elasticity may be greater around corners or areas of complex curvature (e.g., the throat region) to ensure a snug fit in these regions. The edge 640 may also feature a graduated elasticity, with more stretch at the opening to facilitate easy application, and less stretch along the sides to maintain a secure fit during play. The substantially elastic nature of the edge 640 may allow the accessory 600 to accommodate paddles of slightly different sizes and shapes while still providing a substantially consistent, predetermined fit. This adaptability may be particularly useful given the variations in paddle designs across different manufacturers or models. In some implementations, the edge 640 may include additional features to enhance its fitting capabilities. For example, it may incorporate adjustable elements such as drawstrings, elastic cords, or hook-and-loop fasteners that allow users to fine-tune the fit of the accessory 600 to their specific paddle. The elastic properties of the edge 640 may also contribute to the overall durability and longevity of the accessory 600. By allowing for some flexibility and movement, the elastic edge may help prevent tearing or damage that could occur with a more rigid design, especially during repeated application and removal of the accessory 600. Additionally, an elastic edge 640 may help maintain the sound dampening properties of the accessory 600 by ensuring consistent contact between the accessory 600 and the paddle surface. This snug fit may prevent air gaps or loose areas that could potentially reduce the effectiveness of the sound dampening features.

Thus, as described and shown herein, implementations of the present teachings may include a noise control accessory for a pickleball paddle—e.g., where this accessory includes: the sound dampening material 210 of FIG. 2; the sound dampening material 310 of FIG. 3; the sound dampening surface 410 of FIG. 4; the sound dampening feature 510 of FIG. 5; the accessory 600 of FIGS. 6-8; or similar such accessories. The noise control accessory may generally include an outer surface and a sound dampening component.

The outer surface may be structurally configured for striking a ball. And by way of example, this outer surface may correspond to the top surface 202 of FIG. 2, the top surface 302 of FIG. 3, the face 402 of FIG. 4, the third layer 530 of FIG. 5, and/or the face portion 602 of FIGS. 6-8, or similar. In some aspects, the outer surface comprises a sound dampening material itself (e.g., the first sound dampening material as described below)—where examples may include the paddles shown in FIGS. 2 and 3, or similar. Alternatively, the outer surface may include a layer defining a playing surface of a paddle that is coupled with, and covers, at least a majority of the sound dampening component for the paddle. To this end, the outer surface may include one or more of carbon fiber, fiberglass, graphite, a composite material, a metal, or the like. In some aspects, the outer surface may include a textured surface structurally configured for striking the ball and generating a spin on the ball during impact.

The sound dampening component may be structurally configured to engage, directly or indirectly, with a surface of a paddle. That is, the sound dampening component may be placed directly onto a surface of the paddle, where such a surface can include: a playing surface for the paddle (e.g., where the accessory is retrofitted onto or otherwise placed onto a completed paddle), a core portion of the paddle or a surface engaged therewith (e.g., where the accessory is added during a manufacturing process for the paddle before completion thereof, or where the accessory is added to a paddle in which the face has been removed such as in a post-manufacturing repair process or the like, or similar).

The sound dampening component may include a first sound dampening material having a lower density than the surface of the paddle and/or other portions of the paddle. The first sound dampening material may correspond to, for example, the sound dampening material 210 of FIG. 2, the sound dampening material 310 of FIG. 3, the sound dampening surface 410 of FIG. 4, one or more of the layers shown with reference to the sound dampening feature 510 of FIG. 5 (such as the first layer 511, or one or more other layers), generally material included in or on the accessory 600 of FIGS. 6-8, and similar. In general, the first sound dampening material may be structurally configured to reduce noise generated during impact of a paddle with a ball relative to the surface of the paddle directly striking the ball. By way of example, the first sound dampening material may include one or more of the following: a foam material (e.g., where the foam material includes a plurality of open cells, and/or where the foam material includes a plurality of closed cells), a felt material, an elastomeric material, or the like.

The accessory may be configured as a sleeve sized and shaped to fit over at least a majority of a head portion of a paddle—see, e.g., FIGS. 6-8 and the accompanying description above. In such aspects, the accessory may include one piece that slides onto or otherwise couples with a paddle. In other aspects, the accessory may be configured as a clamshell that couples about a head portion of a paddle, a component that is releasably engaged to a surface of a paddle, a component that is permanently engaged to a surface of a paddle, a component that is placed beneath a playing surface of a paddle, and similar. In this manner, the accessory may include two or more pieces that fit together over a paddle.

The accessory may include a bottom surface structurally configured for placement and coupling directly onto a surface of a paddle—e.g., an existing playing surface, a core portion, or otherwise, as described herein. This bottom surface may correspond to, for example, the opposing side of the sound dampening material 210 shown in FIG. 2 that is coupled to the paddle, the opposing side of the sound dampening material 310 shown in FIG. 3 that is coupled to the paddle, the underside of the sound dampening surface 410 that is coupled to the paddle, the bottom layer of the sound dampening feature 510 shown in FIG. 5, or similar. By way of example, the bottom surface may include an affixing mechanism, such as the affixing mechanism 512 of FIG. 5. Such an affixing mechanism may be any as described herein, and for example may include one or more of: a layer formed along the bottom surface, double-sided tape, or similar. The affixing mechanism may also or instead include one or more of a hook and loop fastener, a snap, a magnet, a mechanical keying component, or the like.

In certain aspects, the bottom surface includes an adhesive. In certain aspects, the bottom surface is structurally configured for removal (e.g., in a non-destructive manner) from a paddle after coupling therewith. In other aspects, the bottom surface is structurally configured for permanent coupling with a surface of the paddle.

The sound dampening component may include a plurality of layers. For example, these layers may correspond to the layers shown in reference to the sound dampening feature 510 of FIG. 5. However, it shall be understood that any of the other sound dampening components described herein—such as those with reference to FIGS. 2-4 and FIGS. 6-8—may also or instead include a plurality of layers as described herein. In this manner, in certain aspects, the sound dampening component may include a plurality of layers including a first layer comprising a first sound dampening material, and a second layer comprising a second material. The second material may be a sound dampening material. The second material may also or instead include a lower density than a surface of the paddle (or another portion of the paddle, such as a core thereof). In some aspects, the second layer may include an adhesive. And in some aspects, the second layer may include the outer surface for the accessory.

The plurality of layers may further include a third layer. For example, in certain aspects, the first sound dampening material of the first layer is less dense than each of the second layer and the third layer, the second layer is disposed above the first layer, the second material of the second layer includes at least one of a polyethylene material and an adhesive, and the third layer defines the outer surface for the accessory. In some cases, the accessory may further include a fourth layer. The fourth layer may include an affixing mechanism, such as any as described herein.

As described herein, in certain aspects, a pickleball paddle may include sound dampening features—such as any as described herein—disposed on or within the paddle. For example, one or more of the sound dampening features may be present between a core of the paddle (or another internal structure, such as a frame) and the outermost surface defining a face of the paddle. For example, a paddle may include: a first face; a second face; a core (or another internal structurally component, where it will be understood that recitation of the core in this context should include other comparable structural components) disposed between the first face and the second face; and a sound dampening component disposed between each of (i) the core and the first face, and (ii) the core and the second face.

The sound dampening component may include a first sound dampening material (such as any as described herein) having a lower density than each of the first face, the second face, and the core of the paddle. The first sound dampening material may be structurally configured to reduce noise generated during impact of the paddle with a ball relative to each of the first face and the second face directly striking the ball.

The sound dampening component may further include a plurality of layers including a first layer comprising the first sound dampening material, and a second layer comprising a second material. The second material may be a sound dampening material. The second layer may include an adhesive. The plurality of layers may further include a third layer. The third layer may define a face of the paddle. Instead, another layer of the plurality of layers may define a face of the paddle.

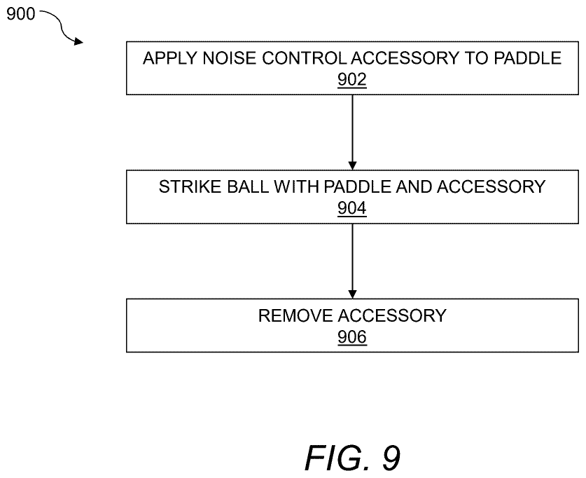

FIG. 9 is a flow chart of a method 900 of noise control for pickleball or the like, in accordance with a representative example. The method 900 may use any one or more of the aspects of the present teachings described herein, such as any shown and described with reference to FIGS. 2-8.

As shown in step 902, the method 900 may include applying a noise control accessory to a pickleball paddle comprising a core (or other internal structural component, such as a frame or the like) disposed between two faces thereof. The noise control accessory may include any as described herein. For example, the noise control accessory may include an outer surface structurally configured for striking a ball, and a sound dampening component structurally configured to engage, directly or indirectly (e.g., engage via an intervening material and/or layer such as an adhesive), with a face of the pickleball paddle. The sound dampening component may include a first sound dampening material having a lower density than the face of the pickleball paddle. The first sound dampening material may be structurally configured to reduce noise generated during impact of the pickleball paddle with the ball relative to the face of the pickleball paddle directly striking the ball.

In certain aspects, applying the noise control accessory to the pickleball paddle includes sliding the noise control accessory onto a head portion of the pickleball paddle. For example, the noise control accessory may be a sleeve sized and shaped to fit over at least a majority of the head portion of the pickleball paddle. In an example aspect, the sleeve includes an edge separating the outer surface and an opposing surface, and an opening sized and shaped for selective insertion of at least a top portion of the pickleball paddle into a pocket defined by a structure of the sleeve. And, in a further example aspect, applying the noise control accessory to the pickleball paddle may further include expanding one or more of the opening and the pocket to receive at least the top portion of the pickleball paddle, and collapsing the opening and/or the pocket to conform to a shape of the pickleball paddle when disposed thereon. Also or instead, applying the noise control accessory to the pickleball paddle may include expanding the edge to receive the pickleball paddle within the pocket, and collapsing the edge to conform to a shape of the pickleball paddle when disposed thereon.

Alternatively, applying the noise control accessory to the pickleball paddle may include placing and coupling the noise control accessory directly onto at least one of the two faces of the pickleball paddle.

As shown in step 904, the method 900 may include striking the ball with the outer surface of the noise control accessory using the combination of the noise control accessory applied onto the pickleball paddle (e.g., striking the ball with the paddle after applying the noise control accessory to the pickleball paddle). As described herein, this may create less noise relative to the paddle striking the ball without the noise control accessory applied thereto.

As shown in step 906, the method 900 may include removing the noise control accessory from the pickleball paddle. This may include, for example, removing a sleeve by sliding it away from the pickleball paddle. This may also or instead include pulling and/or peeling away a noise control accessory from at least one of the two faces of the pickleball paddle. The removal may include removal in a non-destructive manner permitting replacement of the noise control accessory on the paddle in a configuration substantially the same as the configuration prior to removal.

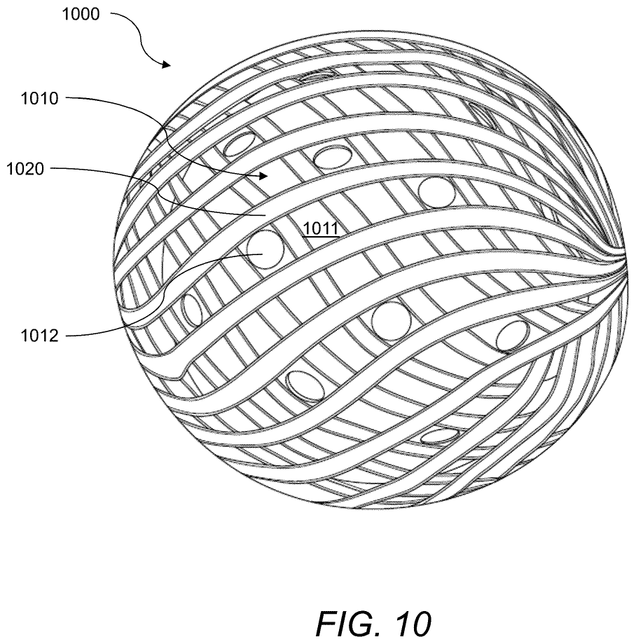

FIG. 10 shows a pickleball ball with one or more sound dampening features, in accordance with a representative example. The ball 1000 may include a first portion 1010 and a second portion 1020.

The first portion 1010 of the ball 1000 may include a standard pickleball shape and material, such as any described herein (e.g., conforming to one or more third-party standards). Thus, in an aspect, the first portion 1010 is merely a standard pickleball ball, such as an off-the-shelf ball or the like. In this manner, the first portion 1010 may be an existing pickleball ball. The ball 1000 may thus include flight and bounce characteristics that comply with one or more predetermined pickleball standards, such as any as described herein or known in the art.

Specifically, the first portion 1010 may be formed of a rigid plastic material or the like. The first portion 1010 may have a substantially spherical shape, where it will be understood that “substantially” in this context shall mean that the ball 1000 appears spherical to an average human user when viewed with the naked eye, and/or where certain inconsistencies (such as due to manufacturing tolerances and the like) do not drastically impact the overall spherical appearance of the ball 1000. The first portion 1010 may include a plurality of holes 1012 about a surface 1011 thereof. The plurality of holes 1012 may lead to an interior portion that is substantially hollow. It will be understood that “substantially” in this context shall mean that a majority of the interior portion of the ball 1000 is devoid of material.

The second portion 1020 of the ball 1000 may include a layer of material arranged in a predetermined pattern, and having a predetermined size and shape. The layer of material may be applied to an outer surface 1011 of the first portion 1010 to form the second portion 1020 thereon and to provide sound dampening qualities for the ball 1000. The layer of material (i.e., the sound dampening material) may be made from a foam material, a felt material, an elastomeric material, an elastomer (e.g., thermoplastic or thermoset), a coating material, or the like. In general, the layer of material may be structurally configured to dampen the vibration caused by impact of the ball 1000 with a surface (e.g., a pickleball paddle, a pickleball court surface, and the like) and absorb at least some of the sound created from such an impact. The layer of material may thus include any of the vibration and/or sound dampening materials described herein, such as in reference to any one or more of FIGS. 2-8.

Therefore, in certain aspects of the present teachings, the second portion 1020 may include a sound dampening material disposed at least partially on the surface 1011 of the first portion 1010. The sound dampening material may have a lower density than the rigid plastic material of the first portion 1010. The sound dampening material may also or instead be structurally configured to reduce noise generated during impact with a paddle or playing surface relative to the first portion 1010 without the second portion 1020 disposed thereon (i.e., relative to a traditional, off-the-shelf pickleball).

In certain aspects, the second portion 1020 is permanently attached to the first portion 1010. For example, in manufacturing such a ball 1000, the first portion 1010 may be formed using a first material (e.g., a hard plastic or similar), and the second portion 1020 may be formed onto the first portion 1010 using a second material (e.g., a foam material or similar). This may, for example, include two-step injection molding process (i.e., two distinct shots of injection molded material) or similar manufacturing techniques. Other manufacturing techniques are also or instead possible.

The second portion 1020 may include a predetermined pattern of the sound dampening material disposed on the surface 1011 of the first portion 1010. The predetermined pattern may be one or more of a weave pattern, a crisscross pattern, a web pattern, or similar. The predetermined pattern may cover less than an entirety of the surface 1011 of the first portion 1010. The second portion 1020 may include regions covering at least a portion of one or more of the plurality of holes 1012. Alternatively, the second portion 1020 may not cover any portion of the plurality of holes 1012.

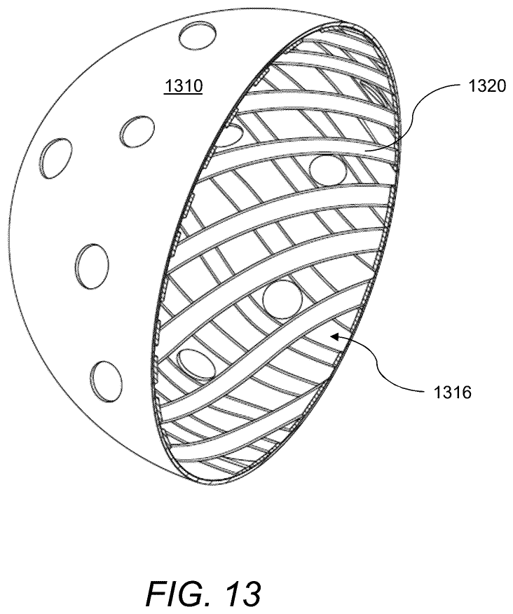

The second portion 1020 is shown disposed on the exterior surface of the first portion 1010 in FIG. 10, but it will be understood that the second portion 1020 may also or instead be disposed on an interior portion of the first portion 1010—see, e.g., FIG. 13 described below.

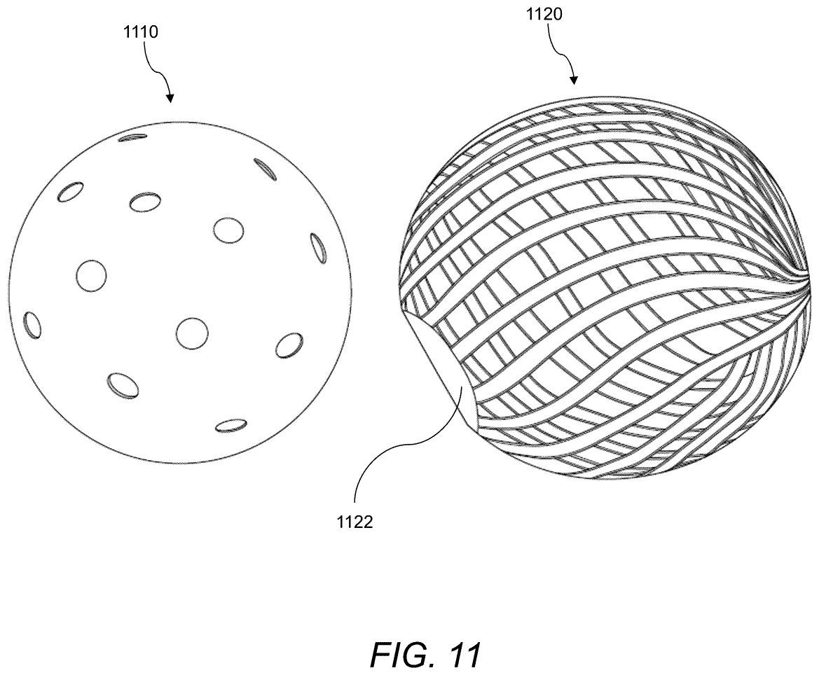

FIG. 11 shows an accessory for a ball and a pickleball ball, in accordance with a representative example. In particular, this figure shows a cover 1120 that forms an accessory for the ball 1110, where the cover 1120 is applicable on the ball 1110 to improve sound dampening properties for the ball 1110. That is, the cover 1120 may be engageable onto the ball 1110—e.g., where the cover 1120 substantially envelopes the ball 1110—to provide a quiet version of a pickleball ball.

Therefore, in an aspect, the second portion (e.g., the cover 1120) is removable and replaceable relative to the first portion (e.g., the ball 1110). Stated otherwise, the second portion may be removably coupled to the first portion. For example, the second portion may be a cover 1120 or the like that can be added to an existing pickleball ball, i.e., selectively applied to, and/or removed from, the first portion. To this end, the second portion itself may be an accessory that a user can add to a pickleball ball to create a relatively quiet ball compared to traditional pickleball balls. For example, the second portion may be formed as a one piece cover 1120 having a cutout (or other type of opening 1122 or the like) structurally configured for receiving the first portion such that the second portion substantially envelopes the ball 1110.

The cover 1120 may be substantially elastic relative to the ball 1110. In such as an aspect, the tension and/or elasticity of the material used to form the second portion can maintain a tight fit around a ball 1110, and/or an adhesive or the like may be used. The cover 1120, or more generally the second portion, may be one piece. Alternatively, the second portion may instead be formed in more than one piece—e.g., two pieces (e.g., two halves/hemispheres) that are structurally configured to be attached with some type of adhesive and/or snap joint system about a pickleball. Stated otherwise, the cover 1120, or more generally the second portion, may include at least two pieces that are structurally configured to attach to each other about the first portion. More pieces are also possible. Such pieces may be attached via a mechanical engagement (e.g., interlocking mechanical components, a snap fit, a friction fit, via nesting with one another, and/or the like). In certain aspects, an adhesive or the like may be used for coupling the second portion to the first portion.

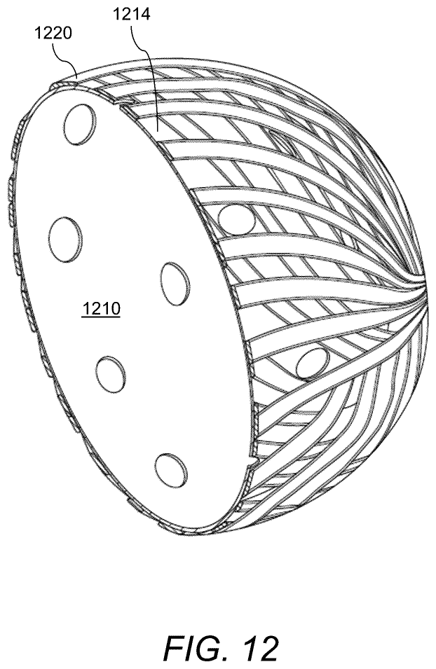

FIG. 12 shows a cutaway view of a pickleball ball with one or more sound dampening features, in accordance with a representative example, having sound dampening features disposed on an exterior portion 1214 of the ball, and FIG. 13 shows a cutaway view of a pickleball ball with one or more sound dampening features, in accordance with a representative example having sound dampening features disposed on an interior portion 1316 of the ball.

That is, as shown in FIG. 12, the surface of the first portion 1210 upon which the second portion 1220 is disposed may be an outer surface of the ball (i.e., along the exterior portion 1214 of the ball). Also, or instead, as shown in FIG. 13, the surface of the first portion 1310 upon which the second portion 1320 is disposed may be an inner surface of the ball, or the second portion 1320 otherwise may be formed in the interior portion 1316 of the ball. For example, in an aspect, both the interior and exterior surfaces of a ball include at least some of the second portion 1220, 1320 disposed thereon. Alternatively, only one of the interior surface or the exterior surface of the ball may include at least some of the second portion 1220, 1320 disposed thereon. As discussed herein, the second portion 1220, 1320 may be structurally configured to dampen vibration caused by impact of the ball with the paddle, playing surface, net (or portion thereof), or similar.

It shall be understood that the second portion 1320 shown in FIG. 13 is engaged with the inner surface of the ball within an interior portion 1316 thereof. Thus, in such an aspect, a majority of the interior portion 1316 remains devoid of material, i.e., the ball remains substantially hollow. However, in an aspect, it shall be understood that other parts of the interior portion 1316 of the ball may also or instead be filled with material of the second portion 1320, or a similar sound dampening material. Thus, certain aspects may include balls that are not substantially hollow.

A ball according to the present teachings—such as any as described herein—can include a plurality of materials including elastomers, foams, composites, and the like. These materials can be incorporated using a plurality of constructions. This includes but is not limited to the ball encasing a foam or encasing another ball that has an air pocket with sound dampening properties, e.g., so as to form a substructure. The substructure can be attached or not attached to the structure of the ball. The substructure may include holes that are aligned or not aligned with the ball whereby the substructure may or may not be attached to the ball.

A ball according to the present teachings may be assembled using one or more of a plurality of welding techniques including but not limited to hot gas welding, ultrasonic welding, vibration welding, spin welding, laser welding, hot plate welding, induction (electromagnetic) welding, extrusion welding, radio frequency welding, or other techniques used to bind polymeric materials together. The assembly can also or instead include a plurality of line geometries ranging from an equatorial line to a curvilinear path wrapping around the ball in a way that creates substantially quiet, uniform performance.

A ball according to the present teachings may or may not conform to certain pickleball standards. For example, instead of a 74 mm ball, the ball may be 78 mm. Other sizes and/or properties are also or instead possible, where such sizes and/or properties may or may not conform to certain pickleball standards.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A pickleball paddle, the paddle comprising:
a first face;
a second face;
a core disposed between the first face and the second face; and
a sound dampening component disposed between each of (i) the core and the first face, and (ii) the core and the second face, the sound dampening component comprising a first sound dampening material having a lower density than each of the first face, the second face, and the core of the paddle, the first sound dampening material structurally configured to reduce noise generated during impact of the paddle with a ball relative to each of the first face and the second face directly striking the ball.

2. The paddle of claim 1, wherein the sound dampening component further comprises a plurality of layers including a first layer comprising the first sound dampening material, and a second layer comprising a second material.

3. The paddle of claim 2, wherein the second material is a sound dampening material.

4. The paddle of claim 2, wherein the second layer comprises an adhesive.

5. The paddle of claim 2, wherein the plurality of layers further includes a third layer.

6. The paddle of claim 5, wherein the third layer defines a face of the paddle.

7. The paddle of claim 2, wherein a layer of the plurality of layers defines a face of the paddle.

8. A method of noise control for pickleball, the method comprising:
applying a noise control accessory to a pickleball paddle comprising a core disposed between two faces thereof, the noise control accessory comprising:
an outer surface structurally configured for striking a ball; and
a sound dampening component structurally configured to engage, directly or indirectly, with a face of the pickleball paddle, the sound dampening component including a first sound dampening material having a lower density than the face of the pickleball paddle, the first sound dampening material structurally configured to reduce noise generated during impact of the pickleball paddle with the ball relative to the face of the pickleball paddle directly striking the ball; and
after applying the noise control accessory to the pickleball paddle, striking the ball with the outer surface of the noise control accessory.

9. The method of claim 8, wherein applying the noise control accessory to the pickleball paddle includes sliding the noise control accessory onto a head portion of the pickleball paddle.

10. The method of claim 9, wherein the noise control accessory is a sleeve sized and shaped to fit over at least a majority of the head portion of the pickleball paddle, the sleeve comprising:
an edge separating the outer surface and an opposing surface; and
an opening sized and shaped for selective insertion of at least a top portion of the pickleball paddle into a pocket defined by a structure of the sleeve.

11. The method of claim 8, further comprising removing the noise control accessory from the pickleball paddle.

12. The method of claim 8, wherein applying the noise control accessory to the pickleball paddle includes placing and coupling the noise control accessory directly onto at least one of the two faces of the pickleball paddle.

13. A noise control accessory for a pickleball paddle, the accessory comprising:
an outer surface structurally configured for striking a ball; and
a sound dampening component structurally configured to engage, directly or indirectly, with a surface of a paddle, the sound dampening component including a first sound dampening material having a lower density than the surface of the paddle, the first sound dampening material structurally configured to reduce noise generated during impact of the paddle with the ball relative to the surface of the paddle directly striking the ball.

14. The accessory of claim 13, wherein the accessory is a sleeve sized and shaped to fit over at least a majority of a head portion of the paddle, the sleeve comprising:
an edge separating the outer surface and an opposing surface; and
an opening sized and shaped for selective insertion of at least a top portion of the paddle into a pocket defined by a structure of the sleeve.

15. The accessory of claim 14, wherein the sleeve is removable and replaceable on the paddle.

16. The accessory of claim 14, wherein the accessory includes a bottom surface structurally configured for placement and coupling directly onto the surface of the paddle, wherein the bottom surface includes an affixing mechanism including at least one of: a layer of adhesive formed along the bottom surface, double-sided tape, a hook and loop fastener, a snap, a magnet, and a mechanical keying component.

17. The accessory of claim 16, wherein the bottom surface is structurally configured for removal from the paddle after coupling therewith.

18. The accessory of claim 16, wherein the bottom surface is structurally configured for permanent coupling with the surface of the paddle.

19. The accessory of claim 14, wherein the first sound dampening material includes at least one of: a foam material, a plurality of open cells, a plurality of closed cells, a felt material, and an elastomeric material.

20. The accessory of claim 14, wherein the sound dampening component includes a plurality of layers including a first layer comprising the first sound dampening material, and a second layer comprising a second material, wherein the second material includes a sound dampening material, an adhesive, or the outer surface.
